(19) United States
(12) Patent Application Publication
(10) Pub. No.: US 2012/0266097 A1
(43) Pub. Date: Oct. 18, 2012

(54) INPUT METHOD AND INPUT DEVICE

(75) Inventors: Jack LAU, Wanchai (HK); Kin Ping NG, Wanchai (HK)

(73) Assignee: PERCEPTION DIGITAL LIMITED, WANCHAI (HK)

(21) Appl. No.: 13/343,098

(22) Filed: Jan. 4, 2012

(30) Foreign Application Priority Data
Apr. 15, 2011 (CN) 201110095638.4

(51) Int. Cl. G06F 3/048

(52) U.S. Cl. 715/773

(57) ABSTRACT

An input method includes: receiving a key instruction generated by a key pressed by a user; obtaining an input instruction according to the key instruction and a predetermined corresponding relationship, and inputting the input instruction. The key of the keyboard are corresponding to the GUI according to their zone, such that when a key is pressed by the user to generate a key instruction, the graphic zone affected by the obtained input instruction is corresponding to the key zone, and the corresponding operations, similar to left click, double click, or right click of the mouse, can be performed to the corresponding graphic zone, thus facilitating the operation of the GUI.

### FIELD OF THE INVENTION

The present disclosure relates to electronics and information technologies, and more particularly relates to an input method and an input device.

### BACKGROUND OF THE INVENTION

The input device has become more and more important since the appearance of the computers. The conventional input devices, such as previous keyboard and lately mouse, have brought convenience for operating the computer. In recent years, there has been widespread application of electronic devices equipped with touch screens. The touch screen can detect the presence and location of a touch within the display area, thus it may replace the keyboard. It has played a prominent role in the design of digital appliances such as tablet computers, mobile phones, personal digital assistant (PDA).

The conventional input devices, such as keyboard, mouse, and touch screen, are employed to different applications according to their unique features. However, those input devices also have some disadvantages. For example, the touch screen for a large display screen suffers from high cost and short operation distance; the keyboard is convenient for typing characters, but it is inconvenient to perform an operation in a graphic user interface (GUI), e.g. selecting one specific zone, etc; the mouse is the best choice for selecting in the GUI, but it needs a substantially flat surface to move around, thus the application environments of the mouse are limited.

Therefore, there is room for improvement within the art.

### SUMMARY OF THE INVENTION

In one aspect of the present disclosure, it is desired to provide an input device which overcomes the inconvenience when operating the GUI via the keyboard.

In one embodiment, an input method includes: step S110, receiving a key instruction generated by a key pressed by a user; step S120, obtaining an input instruction according to the key instruction and a predetermined corresponding relationship, a relative position of a graphic zone affected by the input instruction in a GUI is corresponding to a relative position of a key zone of the key generating the key instruction in a keyboard according to the predetermined corresponding relationship, and step S130, inputting the input instruction.

Preferably, the relative position of the key zone of the key generating the key instruction in a keyboard is the same as the relative position of the graphic zone affected by the input instruction in the GUI.

Preferably, the number of the key zone or the graphic zone is more than two, and there is a one-to-one correspondence between the key zones and the graphic zones.

Preferably, the key zone comprises at least two keys, the key instruction generated by any keys in the same key zone is corresponding to the same input instruction.

Preferably, the at least two keys in one key zone are adjacent in the keyboard.

Preferably, the input method further includes: defining the key zone of the keyboard and the graphic zone of the GUI to build a corresponding relationship between the key instruction and the input instruction.

Preferably, the input instruction is a click operation instruction in the graphic zone of the GUI.

Preferably, the input method further includes: determining whether a zone input mode is activated prior to step S110; proceeding from step S110 to step S130 when the zone input mode is activated; and entering the normal input mode when the zone input mode is not activated.

An input device includes: a receiving module capable of receiving a key instruction generated by a key pressed by a user; a matching module connected to the receiving module, the matching module being capable of obtaining an input instruction according to the key instruction and a predetermined corresponding relationship, a relative position of a graphic zone affected by the input instruction in a GUI is corresponding to a relative position of a key zone of the key generating the key instruction in a keyboard according to the predetermined corresponding relationship; and an input module capable of inputting the input instruction.

Preferably, the number of the key zone or the graphic zone is more than two, and there is a one-to-one correspondence between the key zones and the graphic zones; the key zone comprises at least two adjacent keys, the key instruction generated by any keys in the same key zone is corresponding to the same input instruction.

According to the input method described above, the key of the keyboard are corresponding to the GUI according to their zone, such that when a key is pressed by the user to generate a key instruction, the graphic zone affected by the obtained input instruction is corresponding to the key zone, and the corresponding operations, similar to left click, double click, or right click of the mouse, can be performed to the corresponding graphic zone, thus facilitating the operation of the GUI.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic flow-chart of an embodiment of an input method;

FIG. 2 shows a schematic zone definition of an embodiment of a keyboard;

FIG. 3 shows a schematic zone definition of an embodiment of a GUI;

FIG. 4 is a schematic block diagram illustration of an embodiment of an input device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

The conventional keyboard serves as an input device for inputting the characters only. In embodiments described below, various operations are performed according to a relative position of a key located in the keyboard, such that the functionality of the conventional keyboard is extended.

Referring to FIG. 1, an embodiment of the input method includes following steps.

In step S110, a key instruction generated by a key pressed by a user is received. The key instruction may be generated by a key from a standard PC keyboard, or a mobile phone keyboard or a remote control keyboard based on a conventional keyboard technology. Details of the conventional keyboard technology do not need to repeat in the present disclosure.

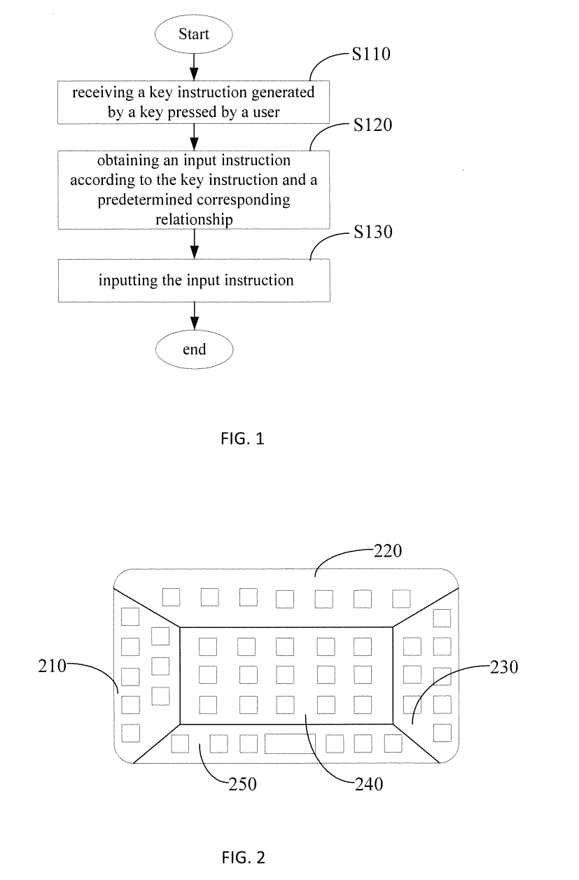

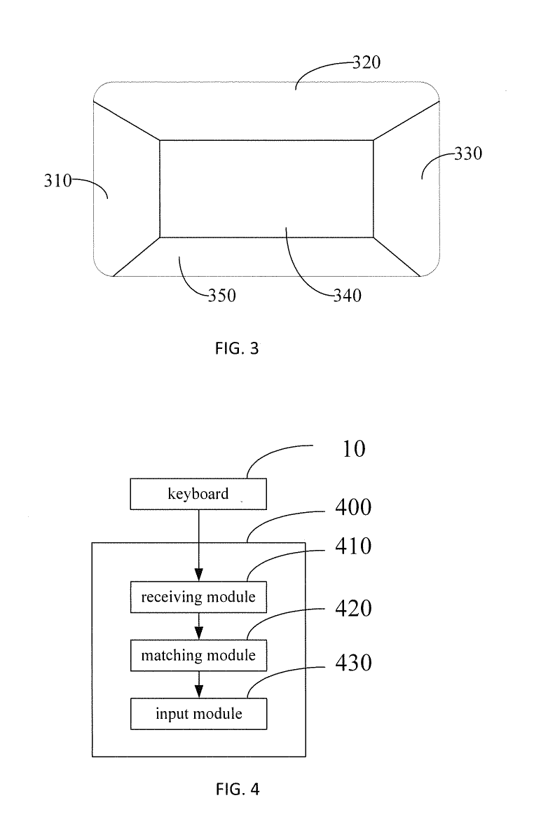

In step S120, an input instruction is obtained according to the key instruction and a predetermined corresponding relation between the input instruction and key instruction. The corresponding relation is predetermined to set a correspondence between a key zone of the key and a graphic zone affected by the input instruction. Referring to FIG. 2, a keyboard 200 defines five key zones, such as a first key zone 210, a second key zone 220, a third key zone 230, a fourth key zone 240, and a fifth key zone 250. Referring to FIG. 3, a GUI (Graphic User Interface) 300 defines five graphic zones, such as a first graphic zone 310, a second graphic zone 320, a third graphic zone 330, a fourth graphic zone 340, and a fifth graphic zone 350. The first key zone 210, the second key zone 220, the third key zone 230, the fourth key zone 240, and the fifth key zone 250 are corresponding to the first graphic zone 310, the second graphic zone 320, the third graphic zone 330, the fourth graphic zone 340, and the fifth graphic zone 350, respectively. When a key in the first key zone 210 is pressed to generate a key instruction, the graphic zone affected by the input instruction obtained according to the key instruction and the corresponding relationship will be the first graphic zone 310; when a key in the second key zone 220 is pressed to generate a key instruction, the graphic zone affected by the input instruction obtained according to the key instruction and the corresponding relationship will be the second graphic zone 320, and so on and so forth. In other words, a relative position of a graphic zone affected by the input instruction in a GUI is corresponding to a relative position of a key zone of the key generating the key instruction in a keyboard according to the predetermined corresponding relationship.

It is to be understood that, the number of the key zone or the graphic zone may be varied accordingly, and the number is preferably more than two. There is a one-to-one correspondence between the key zones and the graphic zones. In a preferable embodiment, the relative position of the key zone of the key generating the key instruction in a keyboard is exactly the same as the relative position of the graphic zone affected by the input instruction in the GUI. For example, the first key zone 210 is located in a left side of the keyboard, and the first graphic zone 310 is also located in a left side of the GUI; the fourth key zone 240 is located in a middle portion of the keyboard, and the fourth graphic zone 340 is also located in a middle portion of the GUI. It is to be understood that, under some circumstances with less demanding, especially when the shape of the keyboard is not in accordance with that of the GUI, the corresponding relationship of the key zone and the graphic zone may not be strictly limited, as long as their relative positions are approximately corresponding with each other, similar operation could also be processed.

In the illustrated embodiment, one key zone of the keyboard includes at least two keys, and the key instruction generated by any keys in the same key zone is corresponding to the same input instruction. Under such configuration, instead of searching for one specific key, the user can simply press any keys in the corresponding key zone to operate the desired graphic zone. In order to prevent the misoperation, the at least two keys in one key zone are adjacent to each other in the keyboard.

In step S130, the input instruction is inputted. The input instruction may be customized. For example, the input instruction may be a click operation instruction in the graphic zone of the GUI. The click operation instruction may be similar to the left click of the mouse. The input instruction may also be the operation instruction similar to the right click or the double click of the mouse. The input instruction may also be zooming-in operation instruction, etc. When an operating system receives the input instruction, the user can perform the corresponding operations, such as open a new GUI, zoom in a graphic zone, etc.

According to the input method described above, the key of the keyboard are corresponding to the GUI according to their zone, such that when a key is pressed by the user to generate a key instruction, the graphic zone affected by the obtained input instruction is corresponding to the key zone, and the corresponding operations, similar to left click, double click, or right click of the mouse, can be performed to the corresponding graphic zone, thus facilitating the operation of the GUI.

In alternative embodiment, the input method further includes a step of defining the key zone of the keyboard and the graphic zone of the GUI to build a corresponding relationship between the key instruction and the input instruction. The definition of the key zone in the keyboard or the graphic zone in the GUI may be customized. For example, regarding to a complicated GUI, a relative large number of graphic zones can be defined, and the number of the key zone can be increased accordingly; on the contrary, regarding to a simple GUI, a relative small number of the graphic zones and a fewer key zones are preferred.

In a preferable embodiment, prior to step S110, the input method further includes a step of determining whether a zone input mode is activated. If the zone input mode is activated, the method proceeds from step S110 to step S130. If the zone input mode is not activated, the method enters the normal input mode, i.e. processing the key instruction generated by a pressed key in a normal way, such as typing characters. The ways to activate the zone input mode can be customized, for example, a predetermined set of keys are pressed simultaneously, or a specific switch on the keyboard is designated to activate or deactivate the zone input mode.

Referring to FIG. 4, an embodiment of an input device 400 is connected to the keyboard 10 via wire or wireless technology. Some operations can be performed according to positions of the keys in the keyboard 10, such that the functionality of the conventional keyboard is extended. The input device 400 includes a receiving module 410, a matching module 420, and an input module 430.

The receiving module 410 is capable of receiving the key instruction generated by the key pressed by the user. The key instruction may be generated by a key from a standard PC keyboard, or a mobile phone keyboard or a remote control keyboard based on a conventional keyboard technology.

The matching module 420 is connected to the receiving module 410. The matching module is capable of obtaining an input instruction according to the key instruction and a predetermined corresponding relationship. The corresponding relationship is predetermined to set the correspondence between a key zone of the key and a graphic zone affected by the input instruction. Referring to FIG. 2, a keyboard 200 defines five key zones, such as a first key zone 210, a second key zone 220, a third key zone 230, a fourth key zone 240, and a fifth key zone 250. Referring to FIG. 3, a GUI (Graphic User Interface) 300 defines five graphic zones, such as a first graphic zone 310, a second graphic zone 320, a third graphic zone 330, a fourth graphic zone 340, and a fifth graphic zone 350. The first key zone 210, the second key zone 220, the third key zone 230, the fourth key zone 240, and the fifth key zone 250 are corresponding to the first graphic zone 310, the second graphic zone 320, the third graphic zone 330, the fourth graphic zone 340, and the fifth graphic zone 350, respectively. When a key in the first key zone 210 is pressed to generate a key instruction, the graphic zone affected by the input instruction obtained according to the key instruction and the corresponding relationship will be the first graphic zone 310; when a key in the second key zone 220 is pressed to generate a key instruction, the graphic zone affected by the input instruction obtained according to the key instruction and the corresponding relationship will be the second graphic zone 320, and so on and so forth. In other words, a relative position of a graphic zone affected by the input instruction in a GUI is corresponding to a relative position of a key zone of the key generating the key instruction in a keyboard according to the predetermined corresponding relationship. In a preferable embodiment, the number of the key zone or the graphic zone is more than two. There is a one-to-one correspondence between the key zones and the graphic zones. The key zone includes at least two adjacent keys; the key instruction generated by any keys in the same key zone is corresponding to the same input instruction.

The input module 430 is capable of inputting the input instruction. The input instruction may be customized For example, the input instruction may be a click operation instruction in the graphic zone of the GUI. The click operation instruction may be similar to the left click of the mouse. The input instruction may also be the operation instruction similar to the right click or the double click of the mouse. The input instruction may also be zooming operation instruction, etc. When an operating system receives the input instruction, the user can perform the corresponding operations, such as open a new GUI, zoom in a graphic zone, etc.

The described input method and input device can be applied to set-top boxes. The keyboard is wirelessly connected to the set-top box, and the set-top box is connected to the TV set to display a GUI on the TV screen. For example, the keys “', 1, 2, 3, 4, 5, Tab, Q, W, E, R, T” of the remote control keyboard are defined as the first key zone; the keys “6, 7, 8, 9, 0, −, =, Backspace, Y, U, I, O, P, [, ], \” are defined as the second key zone; the keys “ Caps lock, A, S, D, F, G, left shift, Z, X, C, V, B” are defined as the third key zone; the keys “H, J, K, L, ;, ', enter, N, M, ,, ., /, right shift” are defined as the fourth key zone. Accordingly, the GUI defines the first graphic zone, the second graphic zone, the third graphic zone, and the fourth graphic zone. The first graphic zone can be information about newly published books of a website; the second graphic zone can be information about stocks; the third graphic zone can be information about news; the fourth graphic zone can be users' favorites (such as cars, entertainments or sports information). According to the method described above, when the user presses a key, e.g. “W” or “4”, in the first key zone to generate a key instruction, the input instruction opening information about newly published books will be inputted. When presses a key, e.g. “O”, in the second key zone, which is corresponding to the second graphic zone, the input instruction opening the information about stocks will be inputted. In conclusion, the user can quickly access the graphic zone in the GUI through the keyboard, other than the mouse or the touch panel, thus inputting becomes convenient. It is to be understood that, besides the set-top box and remote control for the set-top box, the described input method and input device can also be applied to TV set and remote control for the TV set, personal computer and keyboard for personal computer.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. An input method, comprising:
step S110, receiving a key instruction generated by a key pressed by a user;
step S120, obtaining an input instruction according to the key instruction and a predetermined corresponding relationship, wherein a relative position of a graphic zone affected by the input instruction in a GUI is corresponding to a relative position of a key zone of the key generating the key instruction in a keyboard according to the predetermined corresponding relationship, and
step S130, inputting the input instruction.

2. The input method according to claim 1, wherein the relative position of the key zone of the key generating the key instruction in a keyboard is the same as the relative position of the graphic zone affected by the input instruction in the GUI.

3. The input method according to claim 1 or claim 2, wherein the number of the key zone or the graphic zone is more than two, and there is a one-to-one correspondence between the key zones and the graphic zones.

4. The input method according to claim 3, wherein the key zone comprises at least two keys, the key instruction generated by any keys in the same key zone is corresponding to the same input instruction.

5. The input method according to claim 4, wherein the at least two keys in one key zone are adjacent in the keyboard.

6. The input method according to claim 3, further comprising: defining the key zone of the keyboard and the graphic zone of the GUI to build a corresponding relationship between the key instruction and the input instruction.

7. The input method according to claim 1, wherein the input instruction is a click operation instruction in the graphic zone of the GUI.

8. The input method according to claim 1, further comprising:
determining whether a zone input mode is activated prior to step S110;
proceeding from step S110 to step S130 when the zone input mode is activated; and
entering the normal input mode when the zone input mode is not activated.

9. An input device, comprising:
a receiving module capable of receiving a key instruction generated by a key pressed by a user;
a matching module connected to the receiving module, the matching module being capable of obtaining an input instruction according to the key instruction and a predetermined corresponding relationship, wherein a relative position of a graphic zone affected by the input instruction in a GUI is corresponding to a relative position of a key zone of the key generating the key instruction in a keyboard according to the predetermined corresponding relationship; and
an input module capable of inputting the input instruction.

10. The input device according to claim 9, wherein the number of the key zone or the graphic zone is more than two, and there is a one-to-one correspondence between the key zones and the graphic zones; the key zone comprises at least two adjacent keys, the key instruction generated by any keys in the same key zone is corresponding to the same input instruction.
